(19) United States
(12) Patent Application Publication
(10) Pub. No.: US 2018/0241828 A1
(43) Pub. Date: Aug. 23, 2018

(54) SYSTEM AND METHOD OF SOCIAL NETWORKING

(71) Applicant: Ryan Christopher Rossi, Orlando, FL (US)

(72) Inventor: Ryan Christopher Rossi, Orlando, FL (US)

(21) Appl. No.: 15/885,660

(22) Filed: Jan. 31, 2018

Related U.S. Application Data
(60) Provisional application No. 62/460,488, filed on Feb. 17, 2017.

(51) Int. Cl. H04L 29/08; H04L 12/58; G06F 3/0482

(52) U.S. Cl. CPC H04L 67/18; G06F 3/0482; H04L 51/32

(57) ABSTRACT

A system and method of social networking. A first computer determines a location of a first user using a global positioning system (GPS) of the first computer. The first computer receives a location of at least one second user sent from a second computer. The first computer displays on a display screen a digital representation of a compass and at least one user connect button located on the compass based on the location of the second user relative to the location of the first user. The first computer then receives a selection of the user connect button by the first user and generates a chat window to facilitate communication between the first user and the second user.

### CROSS-REFERENCE TO RELATED APPLICATION

This application claims the benefit of priority of U.S. provisional application number 62/460,488, filed Feb. 17, 2017, the contents of which are herein incorporated by reference.

### BACKGROUND OF THE INVENTION

The present invention relates to social media and, more particularly, to a social media network that links users together by displaying relative locations.

Social media are computer mediated technologies that facilitate the creation and sharing of information, ideas, career interests and other forms of expression via virtual communities and networks. Users typically access social media services via web-based technologies on desktop computers and laptops or download services that offer social media functionality to their mobile devices (e.g., smartphones and tablet computers). When engaging with these services, users can create highly interactive platforms through which individuals, communities and organizations can share, co-create, discuss, and modify user-generated content or pre-made content posted online. They introduce substantial and pervasive changes to communication between businesses, organizations, communities and individuals.

### SUMMARY OF THE INVENTION

In one aspect of the present invention, a method of social networking comprising the steps of: determining, by a first computer, a location of a first user using a global positioning system of the first computer; receiving, by the first computer, a location of at least one second user sent from at least one second computer; displaying, by the first computer, a digital representation of a compass and at least one user connect button located on the compass based on the at least one location of the second user relative to the location of the first user; receiving, by the first computer, a selection of the user connect button by the first user; and generating a chat window, by the first computer and the at least one second computer, to facilitate communication between the first user and the at least one second user.

These and other features, aspects and advantages of the present invention will become better understood with reference to the following drawings, description and claims.

### BRIEF DESCRIPTION OF THE DRAWINGS

FIG. 1 is a flow chart of an embodiment of the present invention;

FIG. 2A is a schematic view of a step of an embodiment of the present invention;

FIG. 2B is a schematic view of a step of an embodiment of the present invention;

FIG. 2C is a schematic view of a step of an embodiment of the present invention;

FIG. 2D is a schematic view of a step of an embodiment of the present invention;

FIG. 3A is a schematic view of a step of an embodiment of the present invention; and

FIG. 3B is a schematic view of a step of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, the present invention includes a system and method of social networking. The present invention may include a plurality of computers communicating to link users together. A first computer determines a location of a first user using a global positioning system (GPS) of the first computer. The first computer receives a location of at least one second user sent from a second computer. The first computer displays on a display screen a digital representation of a compass and at least one user connect button located on the compass based on the location of the second user relative to the location of the first user. The first computer then receives a selection of the user connect button by the first user and generates a chat window to facilitate communication between the first user and the second user.

The computers of the present invention may include smart phones, tablets, desktops, laptops or a combination thereof. The computers include least a processor and a memory. The computers may execute on any suitable operating system such as IBM's zSeries/Operating System (z/OS), MS-DOS, PC-DOS, APPLE OS, APPLE iOS, APPLE WATCH OS, WINDOWS, UNIX, OpenVMS, ANDROID, an operating system based on LINUX, or any other appropriate operating system, including future operating systems.

In particular embodiments, the computer includes a processor, memory, a user interface, and a communication interface. In particular embodiments, the processor includes hardware for executing instructions, such as those making up a computer program. The memory includes main memory for storing instructions such as computer program(s) for the processor to execute, or data for processor to operate on. The memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to the computers, where appropriate. In particular embodiments, the memory is non-volatile, solid-state memory.

The user interface includes hardware, software, or both providing one or more interfaces for user communication with the computers. As an example and not by way of limitation, the user interface may include a keyboard, keypad, microphone, monitor, mouse, printer, scanner, speaker, still camera, stylus, tablet, touchscreen, trackball, video camera, another user interface or a combination of two or more of these.

The communication interface includes hardware, software, or both providing one or more interfaces for communication (e.g., packet-based communication) between the computers. As an example, and not by way of limitation, communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example, and not by way of limitation, the computers may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computers may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computers may include any suitable communication interface for any of these networks, where appropriate.

The present invention may be in the form of a mobile application on a smart device or a website on a computer to generate a digital compass. The digital compass may be divided into eight sections indicating a different direction relative to user. The geographic locations of third party users (second users) on the perimeter of the compass are based on one or more of the following location data including, but not limited to, real time GPS data from mobile devices such as smart phones, tablets, desktop or laptop computers, IP Addresses, or stored user registration data. Each location corresponds to the actual direction that the front end of the smart device or computer is pointing towards. Once the user chooses a location, the first user is paired with a second user, and is able to accept or decline to chat with the second user. If both users accept, the two users enter a two-way chat screen and if one of the users declines, each respective user is paired with a different user. The idea of using a real compass that corresponds to another person's actual direction and location creates a fun way of interacting with other people around the world.

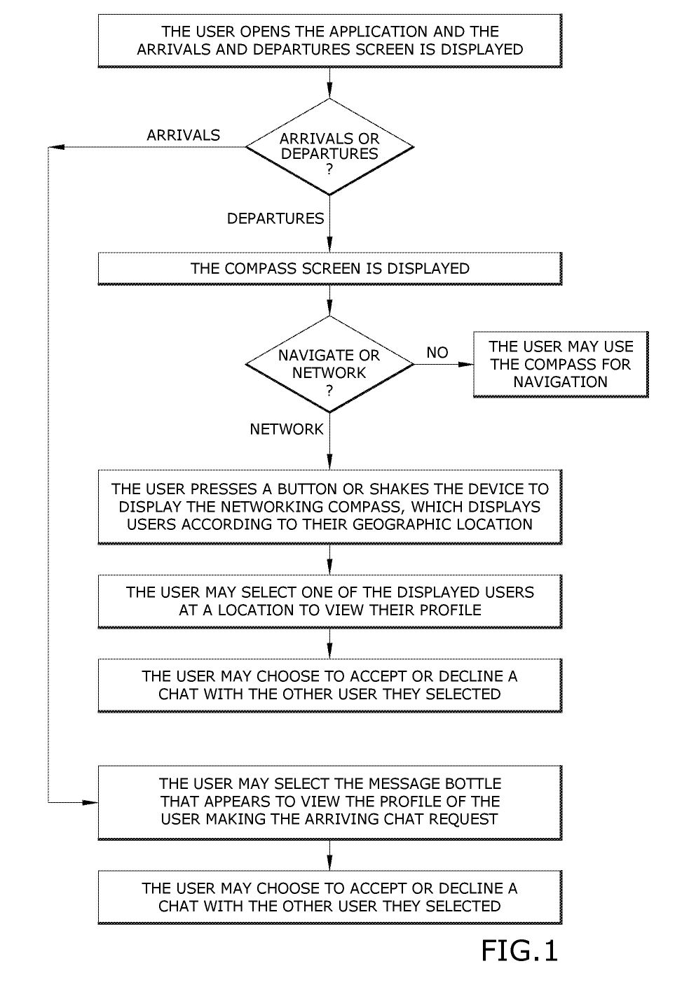

Referring to FIG. 1, the first user opens the application on a smart device. The present invention may include two different modes, an arrivals mode and a departures mode. The arrivals mode receives the requests to chat and the departures mode sends the request to chat. When the application is opened, the arrivals and departures screen is displayed. The first user selects whether they prefer to be in arrivals mode or departures mode. If the first user selects the departures mode, the compass screen is displayed. The first user may select whether they would like to navigate or network. If the first user selects navigate, the user may use the compass as a stand-alone compass to navigate. If the first user selects network, the first user may press a button or shake the smart device to display the networking compass, which displays third party users (second users) according to their geographic location. The first user may select one of the displayed second users at a location to view their profile. The first user may choose to accept or decline a chat with the second user they selected. If the first user selects arrivals, the first user may receive a request from a second user, which may appear in the form of a message bottle. The first user may select the message bottle to view the profile of the second user making the arriving chat request. The first user may choose to accept or decline a chat with the second user they selected.

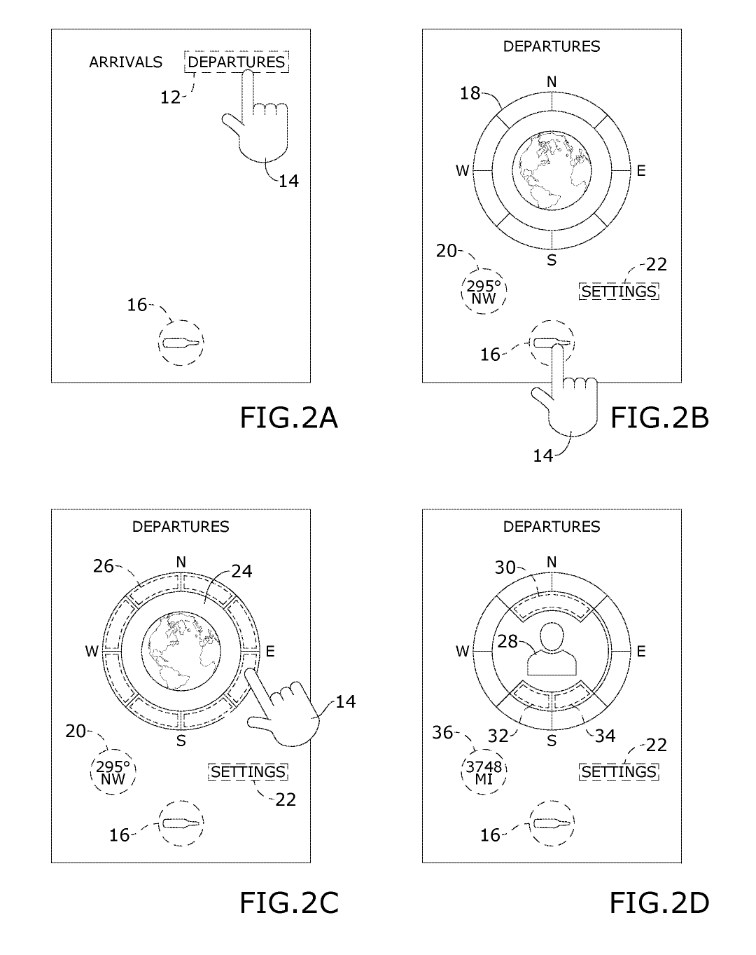

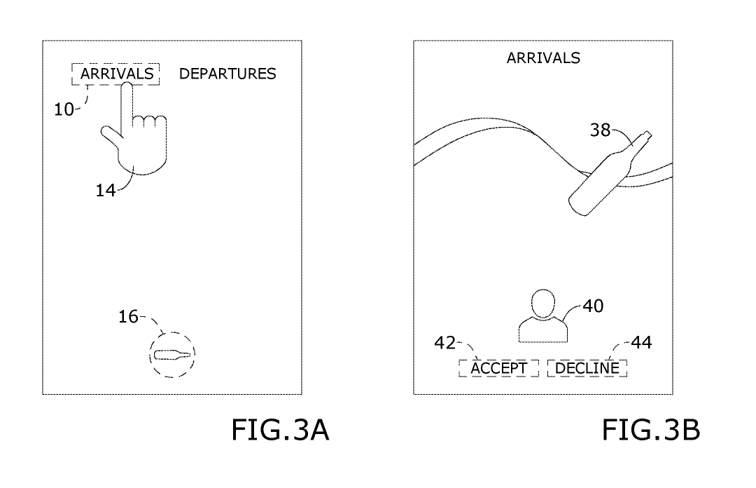

Referring to FIGS. 2A through 3B, the display screen may include a digital representation of an arrivals button 10 and a departures button 12. If a first user 14 selects the departures button 12, a digital representation of a compass 18, a direction and degrees of the user 20, a settings button 22, and a networking button 16 are produced on the display screen. The compass 18 includes directional labels, such as North(N), South(S), East(E) and West (W). Within the compass, a globe of the planet earth may appear and identify the user's location marked by a dot. The user may select the networking button 16. A plurality of user connect buttons 26 are generated and each located on the compass 18 based on the unique location of the plurality of second users relative to the first user. The plurality of user connect buttons 26 are circumferentially disposed about the compass 18. The digital representation of the compass 18 and the plurality of connect buttons 26 adjusts on a display of the smart device based on the direction that the top end of the smart device is facing. The first user 14 may select one of the plurality of connect buttons 26. The computer may then generate a user profile on the display screen. The user profile may include a picture 28 of the selected second user, a name 30 of the second user, a distance 36 between the second user and the first user 14, an accept button 32 and a decline button 34. If the first user 14 selects the accept button 32, a communication is sent from the first user's computer to the second user's computer to generate the digital representation of the accept button 42 and the decline button 44 on the display screen of the second user's computer. If the second user accepts, a chat window between the first user 14 and the second user is created. If the first user 14 selects the arrivals button 10, the first user 14 may wait for other users to select them. If another user selects the first user 14, an arriving message bottle 38, a picture 40 of the other second user, an accept button 42 and a decline button 44 are generated on the first users 14 display screen. If the first user accepts, a chat window between the first user 14 and the second user is created.

It should be understood, of course, that the foregoing relates to exemplary embodiments of the invention and that modifications may be made without departing from the spirit and scope of the invention as set forth in the following claims.

What is claimed is:

1. A method of social networking comprising the steps of:
determining, by a first computer, a location of a first user using a global positioning system of the first computer;
receiving, by the first computer, a location of at least one second user sent from at least one second computer;
displaying, by the first computer, a digital representation of a compass and at least one user connect button located on the compass based on the at least one location of the second user relative to the location of the first user;
receiving, by the first computer, a selection of the user connect button by the first user; and
generating a chat window, by the first computer and the at least one second computer, to facilitate communication between the first user and the at least one second user.

2. The method of claim 1, wherein the first computer and the second computer communicate by at least one telecommunications network and the Internet.

3. The method of claim 1, wherein the first computer is a smart device.

4. The method of claim 3, wherein the digital representation of the compass and the at least one user connect button adjusts on a display of the smart device based on the direction that the top end of the smart device is facing.

5. The method of claim 1, wherein at least one unique location represents a plurality of second users.

6. The method of claim 5, wherein the at least one user connect button comprises of a plurality of user connect buttons each located on the compass based on the unique location of the plurality of second users relative to the first user.

7. The method of claim 6, wherein the plurality of user connect buttons are circumferentially disposed about the compass.

8. The method of claim 1, further comprising the step of displaying, by the second computer, a digital representation of an accept button and a decline button, wherein the selection of the accept button by the second user generates the chat window, and the selection of the decline button by the second user prevents the generation of the chat window.

9. The method of claim 8, wherein a digital picture of the first user is displayed with the digital representation of the accept button and the decline button.

10. The method of claim 8, further comprising the step of displaying, by the first computer, a digital picture of the second user, a distance of the second user from the first user, and a digital representation of an accept button and a decline button, wherein the selection of the accept button prompts a communication with the second computer to generate the digital representation of the accept button and the decline button on the second computer.
